(19) United States
(12) Patent Application Publication
(10) Pub. No.: US 2023/0245454 A1
(43) Pub. Date: Aug. 3, 2023

(54) PRESENTING AUDIO/VIDEO RESPONSES BASED ON INTENT DERIVED FROM FEATURES OF AUDIO/VIDEO INTERACTIONS

(71) Applicant: Aktify, Inc., Lehi, UT (US)

(72) Inventors: Kreg Peeler, Draper, UT (US); Spencer B. Koehler, Sandy, UT (US); Amir Ali Abdullah, Provo, UT (US)

(21) Appl. No.: 18/161,981

(22) Filed: Jan. 31, 2023

Related U.S. Application Data
(60) Provisional application No. 63/304,959, filed on Jan. 31, 2022.

(51) Int. Cl. G06V 20/40; G06F 40/284; G06F 16/783; G06V 40/16; G06V 40/20

(52) U.S. Cl. CPC G06V 20/46; G06F 40/284; G06F 16/7844; G06V 40/176; G06V 40/28

(57) ABSTRACT

Audio/video responses can be provided based on intent derived from features of audio/video interactions. By providing such audio/video responses, a consumer interaction agent can cause a consumer to experience an interactive conversation as good or better than communicating with a human.

### CROSS-REFERENCE TO RELATED APPLICATIONS

This application claims the benefit of U.S. Provisional Application No. 63/304,959 which was filed on Jan. 31, 2022.

### BACKGROUND

Embodiments of the present invention are generally directed to techniques for presenting audio/video responses based on intent derived from features of audio/video interactions. These techniques could be implemented as part of a lead management system, and therefore, an overview of leads is provided below. However, these techniques could also be implemented as part of or on behalf of any system that interfaces with an individual via an audio/video stream.

A lead can be considered a contact, such as an individual or an organization, that has expressed interest in a product or service that a business offers. A lead could merely be contact information such as an email address or phone number, but may also include an individual's name, address or other personal/organization information, an identification of how an individual expressed interest (e.g., providing contact/personal information via a web-based form, signing up to receive periodic emails, calling a sales number, attending an event, etc.), communications the business may have had with the individual, etc. A business may generate leads itself (e.g., as it interacts with potential customers) or may obtain leads from other sources.

A business may use leads as part of a marketing or sales campaign to create new business. For example, sales representatives may use leads to contact individuals to see if the individuals are interested in purchasing any product or service that the business offers. These sales representatives may consider whatever information a lead includes to develop a strategy that may convince the individual to purchase the business's products or services. When such efforts are unproductive, a lead may be considered dead. Businesses typically accumulate a large number of dead leads over time.

Recently, efforts have been made to employ artificial intelligence to identify leads that are most likely to produce successful results. For example, some solutions may consider the information contained in leads to identify which leads exhibit characteristics of the ideal candidate for purchasing a business's products or services. In other words, such solutions would inform sales representatives which leads to prioritize, and then the sales representatives would use their own strategies to attempt to communicate with the respective individuals.

### BRIEF SUMMARY

The present invention extends to systems, methods and computer program products for presenting audio/video responses based on intent derived from features of audio/video interactions. By providing such audio/video responses, a consumer interaction agent can cause a consumer to experience an interactive conversation that is as good or better than communicating with a human.

In some embodiments, the present invention may be implemented as a method for providing audio/video responses to consumers based on intent derived from features of the consumer's audio/video interactions. An audio/video interaction can be received from a consumer. Text can be extracted from the audio/video interaction. One or more features in the text can be identified. An intent of the audio/video interaction can be derived based on the one or more features in the text. An audio/video response can be selected based on the intent. The audio/video response can be presented to the consumer.

In some embodiments, one or more features in the audio/video content of the audio/video interaction can also be identified, and the intent may be derived based also on the one or more features in the audio/video content.

In some embodiments, the audio/video response may be an audio/video clip that includes a human speaking or a rendering of an avatar speaking. The avatar may or may not resemble a human.

In some embodiments, the one or more features in the text can be identified by performing natural language processing to determine one or more tokens that appear in the text.

In some embodiments, the one or more features in the text can be identified by generating a tokenized version of the text.

In some embodiments, the one or more features in the audio/video content of the audio/video interaction can be identified by detecting one or more of a tone, body language, or facial expression of the consumer.

In some embodiments, the tone, body language, or facial expression of the consumer can be detected by detecting when voice content of the audio/video content represents excitement, reluctance, or uncertainty.

In some embodiments, the tone, body language, or facial expression of the consumer can be detected by detecting particular facial expressions or hand gestures.

In some embodiments, the tone, body language, or facial expression of the consumer may be detected using artificial intelligence.

In some embodiments, one or more timestamps can be associated with the text and the one or more timestamps can be used to link at least one of the one or more features in the text with at least one corresponding feature of the one or more features in the audio/video content.

In some embodiments, the audio/video response can be selected based on the intent by selecting the audio/video response from among multiple audio/video responses that match the intent that is derived based on the one or more features in the text.

In some embodiments, the audio/video response can be selected from among the multiple audio/video responses that match the intent that is derived based on the one or more features in the text by selecting the audio/video response based on the intent that is derived based also on the one or more features in the audio/video content.

In some embodiments, the intent may be one of busy, busy and anxious, affirmative answer, affirmative answer and sad, affirmative answer and excited, or negative answer.

In some embodiments, the audio/video response can be presented to the consumer by dynamically generating data for rendering an avatar by which the audio/video response is presented.

In some embodiments, the intent may be derived based also on previous interactions with the consumer or information known about the consumer.

In some embodiments, the consumer can be connected with a human after presenting the audio/video response to the consumer.

In some embodiments, the text extracted from the audio/video interaction and text of the audio/video response can be presented to the human to thereby provide context to the human.

In some embodiments, the present invention can be implemented as computer storage media storing computer executable instructions which when executed implement a method for providing audio/video responses to consumers based on intent derived from features of the consumer's audio/video interactions. An audio/video interaction can be received from a consumer. Text can be extracted from the audio/video interaction. One or more features in the text can be identified. One or more features in the audio/video content of the audio/video interaction can also be identified. An intent of the audio/video interaction can be derived based on the one or more features in the text and the one or more features in the audio/video content. An audio/video response can be selected based on the intent. The audio/video response can be presented to the consumer.

In some embodiments, the present invention may be implemented as a method for providing audio/video responses to consumers based on intent derived from features of the consumer's audio/video interactions. Audio/video interactions can be received from a consumer. Text can be extracted from the audio/video interactions. Features in the text can be identified using artificial intelligence to detect one or more of a tone, body language, or facial expression of the consumer during the audio/video interactions. Intents of the audio/video interactions can be derived based on the features in the text. Audio/video responses can be selected based on the intents. The audio/video responses can be presented to the consumer.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIGS. 1A and 1B each illustrate an example computing environment in which one or more embodiments of the present invention may be implemented;

FIGS. 2A and 2B provide examples of various components that a lead management system and an audio/video communications system respectively may include in accordance with one or more embodiments of the present invention;

FIG. 3 provides an example of how audio/video responses can be selected and presented to a consumer based on intent derived from features of the consumer's audio/video interactions;

FIG. 4 provides another example of how audio/video responses can be selected and presented to a consumer based on intent derived from features of the consumer's audio/video interactions; and

FIG. 5 provides an example of an audio/video response database may be configured in accordance with one or more embodiments of the present invention.

### DETAILED DESCRIPTION

In the specification and the claims, the term “consumer” should be construed as an individual. A consumer may or may not be associated with an organization. The term “lead” should be construed as information about, or that is associated with, a particular consumer. The term “consumer computing device” can represent any computing device that a consumer may use and by which an audio/video communication system may communicate with the consumer. In a typical example, a consumer computing device may be a consumer's phone.

As an overview, embodiments of the present invention can be used to have audio/video interactions (e.g., video calls) with a consumer without the involvement of a human. In other words, embodiments of the present invention enable consumers to have video calls or other forms of audio/video interactions with what may appear to be a human when in fact a consumer interaction agent is on the other end of the video calls. Embodiments of the present invention employ techniques for selecting and presenting audio/video responses based on intent derived from features of the consumer's audio/video interactions. Such techniques enable the consumer interaction agent to present a representation of a human that responds to and interacts with the consumer as a human would.

Embodiments of the present invention are primarily described in the context of a lead management system that is designed to assist a business in contacting and communicating with its leads. However, embodiments of the present invention could be implemented whenever it may be desired or useful to have audio/video interactions with individuals. For example, such individuals could have initiated the audio/video interactions without prior involvement of any business and/or without any prior knowledge of or information about the individuals.

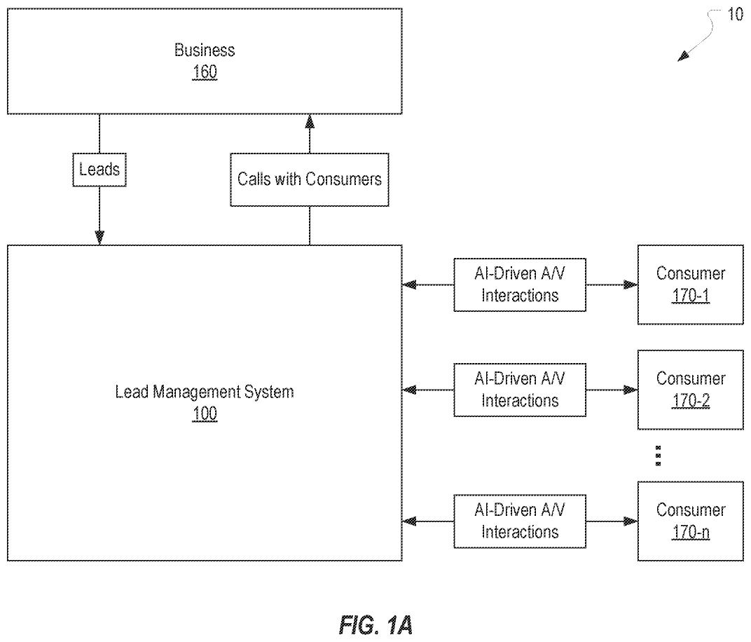

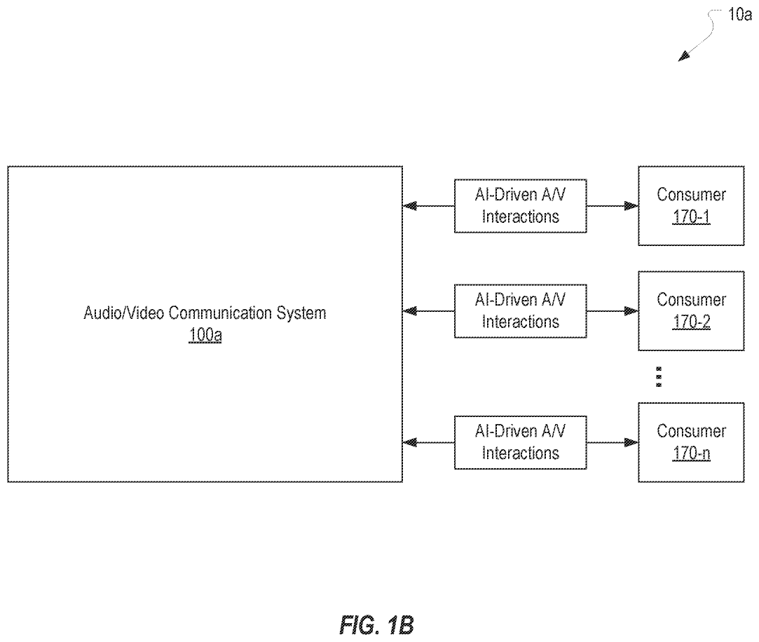

FIG. 1A provides one example of a computing environment 10 in which embodiments of the present invention may be implemented. Computing environment 10 may include a lead management system 100, a business 160 and consumers 170-1 through 170-n (or consumer(s) 170) which may use consumer computing devices (not shown). Business 160 can provide leads to lead management system 100 where the leads can correspond with consumers 170. Typically, these leads may be dead leads that business 160 has accumulated, but any type of lead may be provided in embodiments of the present invention. Although only a single business 160 is shown, there may typically be many businesses 160.

Lead management system 100 can perform a variety of functionality on the leads to enable lead management system 100 to have AI-driven interactions, including audio/video interactions, with consumers 170. For example, these AI-driven interactions can be audio/video calls that are intended to convince consumers 170 to have a video call, phone call, or other interaction with a sales representative (or agent) of business 160. Once the AI-driven interactions with a particular consumer 170 are successful (e.g., when the particular consumer 170 agrees to a video call with business 160), lead management system 100 may initiate/connect a video call between the particular consumer 170 and a sales representative of business 160. Accordingly, by only providing its leads, including its dead leads, to lead management system 100, business 160 can obtain video calls or other interactions with consumers 170.

FIG. 1B provides another example of a computing environment 10a in which embodiments of the present invention may be implemented. Computing environment 10a includes an audio/video communication system 100a and consumers 170-1 through 170-n which have AI-driven audio/video interactions. FIG. 1B is intended to represent that embodiments of the present invention need not be implemented in lead-based systems but could be implemented in any system that is configured to have audio/video communications with consumers. Notably, computing environment 10a is not shown as including business 160 to thereby represent that a business could provide, but need not provide, leads to audio/video communication system 100a to enable it to implement embodiments of the present invention. For example, consumers 170-1 through 170-n could provide such “leads” directly to audio/video communication system 100a such as by exchanging text messages or submitting a form prior to the audio/video communications or as part of the audio/video communications. Accordingly, the exact manner in which AI-driven audio/video interactions are initiated are not essential to embodiments of the present invention.

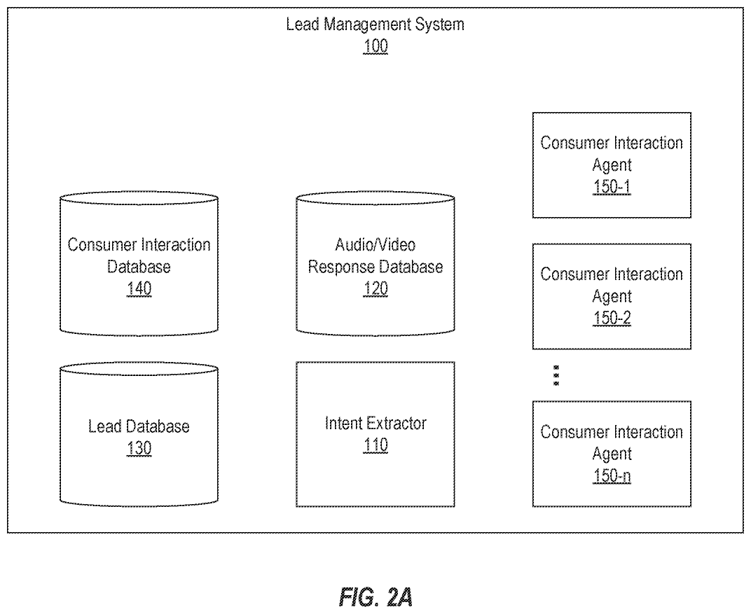

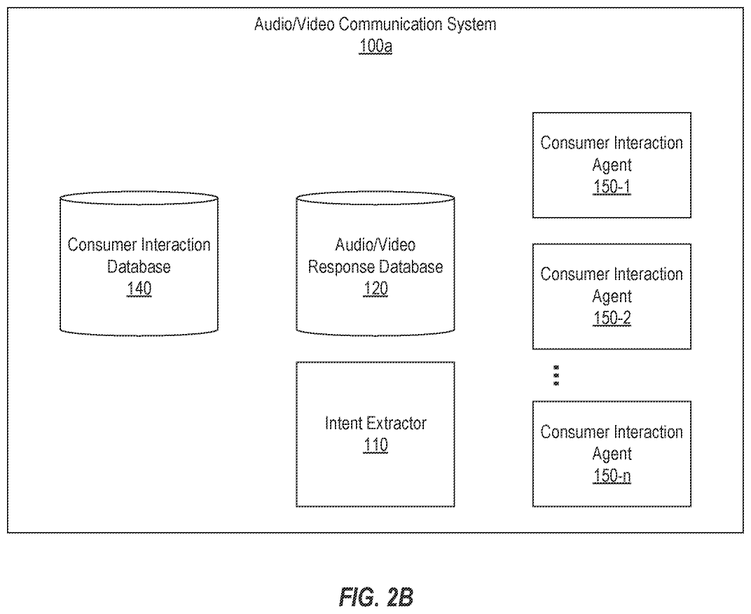

FIG. 2A provides an example of various components that lead management system 100 may include in one or more embodiments of the present invention. These components may include an intent extractor 110, an audio/video response database 120, a lead database 130, a consumer interaction database 140, and consumer interaction agents 150-1 through 150-n (or consumer interaction agent(s) 150).

Intent extractor 110 can represent one or more components of lead management system 100 that are configured to extract/derive intent from features of audio/video interactions received by consumer interaction agents 150. Audio/video response database 120 can represent one or more data storage mechanisms that store audio/video clips (e.g., pre-recorded audio/video of a human) that consumer interaction agents 140 can use as responses to audio/video interactions they have with consumers. Alternatively or additionally, audio/video response database 120 could include data for rendering audio/video responses for consumer interaction agents 150 to use (e.g., audio/video of a rendered avatar of a human, an animal, a cartoon, or other non-human thing). Lead database 130 can represent one or more data storage mechanisms for storing leads or data structures defining leads. Consumer interaction database 140 can represent one or more data storage mechanisms for storing consumer interactions or data structures defining consumer interactions.

Consumer interaction agents 150 can be configured to interact with consumers 170 via consumer computing devices. For example, consumer interaction agents 150 can communicate with consumers 170 via text messages, emails, another text-based mechanism, or, of primary relevance to embodiments of the present invention, audio and video such as video calls. These interactions can be stored in consumer interaction database 140 and associated with the respective consumer 170 (e.g., via associations with the corresponding lead defined in lead database 130).

In some embodiments, lead management system 100 could include a business appointment initiator that is configured to initiate an appointment (e.g., a video call, phone call, or similar communication) between a consumer 170 and a representative of business 160. For example, a business appointment initiator could establish a call with a consumer and then connect the business representative to the call. As described in U.S. patent application Ser. No. 17/346,032 (the “'032 Application”), which is incorporated herein by reference, a business appointment extractor can intelligently select the timing of such appointments by applying a scheduling language and model to the consumer interactions, including AI-driven audio/video interactions, that consumer interaction agents 150 have with consumers 170.

In some embodiments, lead management system 100 could include a dynamic lead outreach engine that can be used to determine the timing, content, and the like of a next interaction with a consumer as described in U.S. patent application Ser. No. 17/347,207, which is incorporated herein by reference. In other words, a dynamic lead outreach engine could be used when lead management system 100 initiates the AI-driven interactions with a consumer (e.g., based on previous interactions with the consumer or other information known about the consumer). However, in embodiments of the present invention, the consumer may initiate the AI-driven interactions (e.g., by initiating a video call) regardless of whether lead management system 100 has any prior knowledge of the consumer.

In some embodiments, lead management system 100 could include a lead data processor for processing lead data to facilitate the AI-driven interactions with consumers as described in U.S. patent application Ser. No. 17/346,055, which is incorporated herein by reference.

FIG. 2B shows that audio/video communication system 100a may also include consumer interaction agents 150, intent extractor 110, audio/video response database 120, and consumer interaction database 140, but may not include lead database 130 (e.g., when audio/video communication system 100a does not leverage leads to have AI-driven interactions with consumers).

In both FIGS. 2A and 2B, consumer interaction agents 150 and intent extractor 110 are shown as separate components. However, embodiments of the present invention should not be limited to any particular organization or structuring of the components that provide the functionality described herein. For example, in some embodiments, the functionality of intent extractor 110 could be implemented within consumer interaction agent 150.

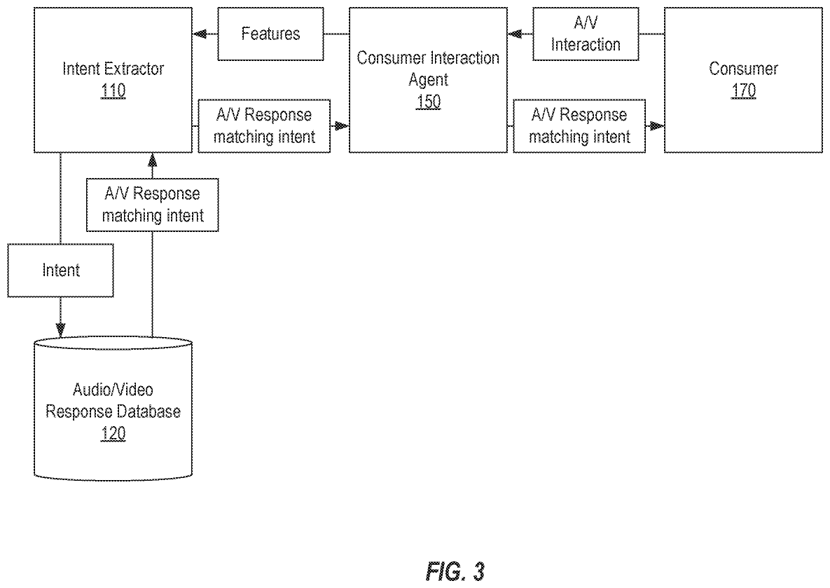

FIG. 3 provides an overview of how embodiments of the present invention may provide audio/video responses, such as in the form of audio/video clips of a human or rendered audio/video content that includes an avatar, based on intent derived from features of audio/video interactions. As shown, a consumer 170 can have audio/video interactions with a consumer interaction agent 150. For example, consumer 170 and consumer interaction agent 150 could establish an audio/video call in which case the audio/video interactions could be the audio/video content captured by a microphone and camera of the consumer computing device during the audio/video call. Consumer interaction agent 150 can receive/capture an audio/video interaction from consumer 170 and process it to identify various features as described in detail below. These features can be provided to intent extractor 110 which can use artificial intelligence to derive an intent from the features. Intent extractor 110 can then retrieve, identify or create an audio/video response matching the intent and provide it to consumer interaction agent 150 (or otherwise enable consumer interaction agent 150 to obtain the audio/video response matching the intent). Consumer interaction agent 150 can then cause the audio/video response matching the intent to be presented to consumer 170.

Although not represented in FIG. 3, in some embodiments, consumer interaction database 140 and/or lead database 130 could be leveraged as part of determining the features of the audio/video interaction and/or as part of deriving the intent from the features. For example, a lead and/or past interactions with consumer 170 could be considered by the artificial intelligence solutions that identify features and/or derive intent.

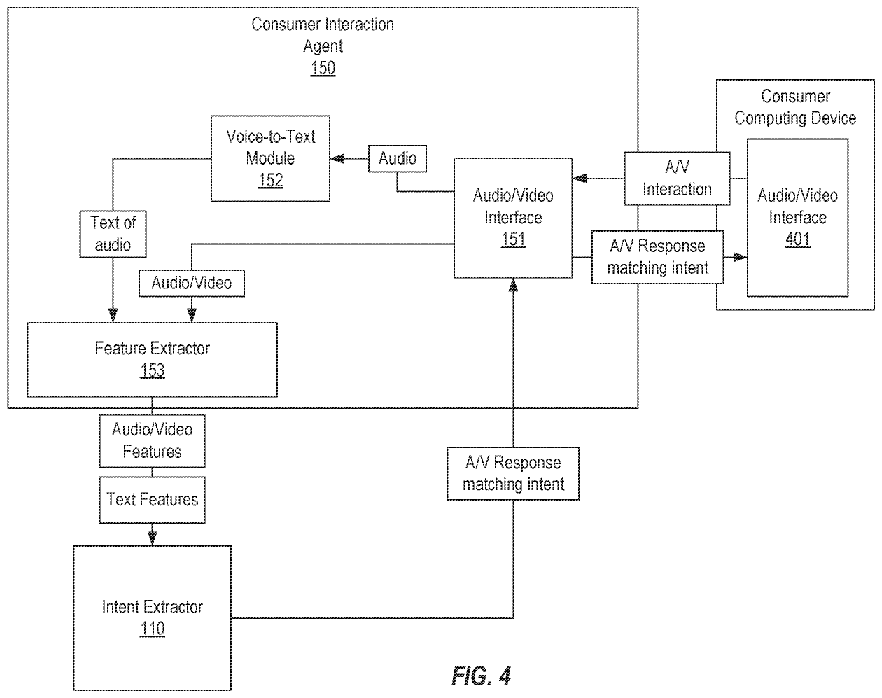

FIG. 4 provides an example of how consumer interaction agent 150 may be configured to generate features of an audio/video interaction. As shown, consumer interaction agent 150 may include an audio/video interface 151 by which it may have audio/video interactions with a consumer computing device (e.g., via an audio/video interface 401 on the consumer computing device). In some embodiments, audio/video interface 151 could be part of or integrated with any of the commonly used video conferencing/call solutions such as Zoom, Teams, FaceTime, etc. Of importance is that audio/video interface 151 allows a consumer using a consumer computing device to have audio/video interactions with consumer interaction agent 150 and enables the audio/video content of such interactions to be processed in the manner described below.

When consumer interaction agent 150 receives an audio/video interaction from the consumer (e.g., a captured portion of the audio/video content that the consumer computing device sends during an audio/video call), audio/video interface 151 (or another suitable component) may extract the audio from the audio/video interaction and provide it to voice-to-text module 152. Voice-to-text module 152 can generate text of the audio and provide the text to feature extractor 153. In some embodiments, the audio/video can also be input to feature extractor 153. Although not shown, in some embodiments, the text of the audio can include one or more timestamps or some other information for linking the text to the corresponding portions of the audio/video.

Feature extractor 153 can employ natural language processing or other suitable techniques to extract features from the text of the audio and, in some embodiments, can employ audio/video processing techniques to extract features from the video. Examples of how features may be extracted from text are provided in the '032 Application. For example, feature extractor 153 may employ natural language processing to determine which tokens (which may be considered one type of feature) appear in the text for the audio. Feature extractor 153 could then output text features which may be in the form of a tokenized version of the text for the audio.

To generate audio/video features from the audio/video, feature extractor 153 may process the audio/video to detect the consumer's tone, body language, facial expression, etc. For example, feature extractor 153 could use artificial intelligence (e.g., a machine learning algorithm) to detect when voice content represents excitement, reluctance, uncertainty, or any other emotion that may be conveyed via tone. Similarly, feature extractor 153 could use artificial intelligence (e.g., a machine learning algorithm) to detect particular facial expressions, hand gestures, or other body language that convey a particular emotion that may be present in the video content. Accordingly, each audio/video feature that feature extractor 153 generates can represent an occurrence of an emotion or other audible/visual expression that is detected in the audio/video interaction. As stated above, timestamps or any other suitable information can be used to associate these audio/video features with the corresponding text features (e.g., so that intent extractor 110 can know which emotion/expression the consumer had when speaking a particular word, phrase, sentence, etc.). As one example, one or more timestamps could be used to link the text of a consumer's answer to a question to each audio/video feature that was detected during the consumer's answer.

Feature extractor 153 can then provide the text features and the audio/video features to intent extractor 110. In some embodiments, intent extractor 110 could be configured to employ artificial intelligence (e.g., a machine learning algorithm) to derive an intent from the features. Examples of deriving an intent from text features are provided in the '032 Application. For example, intent extractor 110 could employ a machine learning algorithm that is trained on a model that includes the tokens and patterns to determine which pattern the tokenized version of the text for the audio matches. In such cases, the matched pattern could define the intent. The '032 Application uses examples where the intent relates to the scheduling of a future communication. However, the same or similar techniques could be used to derive any intent such as a particular question that the consumer is asking.

In some embodiments, intent extractor 110 may use the text features alone to derive the intent and therefore to select the matching audio/video response. For example, based only on the text features, intent extractor 110 could determine that the intent of the audio/video interaction is an interest in a particular product or service being discussed. In such a case, intent extractor 110 could query audio/video response database 120 to retrieve an audio/video clip (or response) 120 associated with interest in general or with interest in the particular product or service. As one example, a matching audio/video clip could be a recording of an individual saying “That's great. I'm glad you're interested in this offering.” As another example, a matching audio/video response could be a rendering of an avatar speaking this same content.

In some embodiments, intent extractor 110 may use both the text features and the audio/video features to derive the intent and therefore to select the matching audio/video response. Using the same example as above, if the audio/video features indicate that the consumer was excited during the audio/video interaction (e.g., if the audio/video features indicate that the consumer was smiling, using a higher pitched tone, moving his or her hands in an excited manner, etc.), intent extractor 110 could determine that the intent of the audio/video interaction was excited interest in a particular product or service being discussed. In such a case, intent extractor 110 could select an audio/video clip where the individual says “That's great. I'm glad you're interested in this offering” in an excited tone, with an excited facial expression, and/or with an excited hand gesture. Accordingly, there may be multiple audio/video responses that could match intent based on text features alone where the audio/video response that will be selected in a particular scenario depends on the corresponding audio/video features.

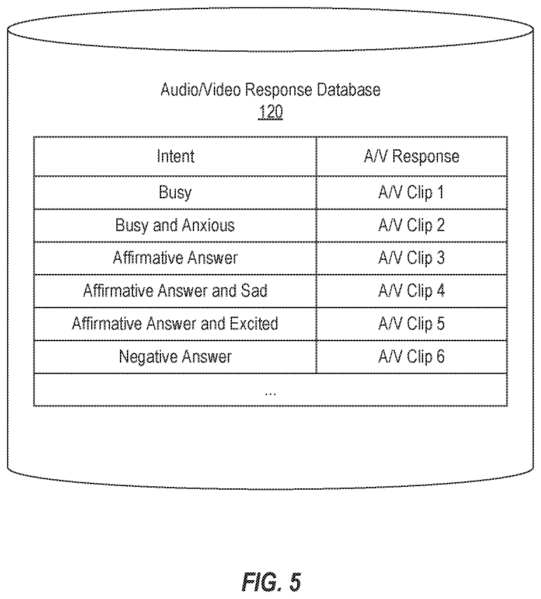

FIG. 5 provides an example of how audio/video response database 120 may associate intents with audio/video responses. As shown, a separate audio/video clip (or data for rendering an audio/video response) could be created for and mapped to each intent so that the audio/video response can be selected and presented to the consumer when the corresponding intent is detected. For example, audio/video clip 1 could be created to present to a consumer when the intent of the consumer's audio/video interaction is determined to be “busy,” and an audio/video clip 2 could be created to present to a consumer when the intent of the consumer's audio video interaction is determined to be “busy and anxious.”

FIG. 5 is a generalized example. However, in some embodiments, audio/video response database 120 could group audio/video responses based on a variety of attributes such as an associated business, a product or service that is the subject of the consumer's interactions, attributes of the consumer, or other context. For example, a first set of audio/video responses could be created for use when interacting with consumers that are interested in a first business' s product or service, and a second set of audio/video responses could be created for use when interacting with consumers that are interested in a second business's product or service. In such a case, the same set (or at least overlapping sets) of intents could be mapped to the audio/video responses in each set of audio/video responses. Accordingly, there could be a one-to-many relationship between an intent and audio/video responses. However, in some embodiments, there may be a one-to-one relationship between an intent and an audio/video response.

In some embodiments, rather than employing pre-created audio/video clips or pre-defined content for rendering an audio/video response, intent extractor 110 (or another component) could dynamically generate an audio/video response. For example, intent extractor 110 could dynamically generate data for rendering an avatar that speaks a response that is tailored specifically to the features of the audio/video interaction and/or the derived intent. As one example, a dynamically generated audio/video response could include an avatar using the consumer's name or other information obtained from the audio/video interaction or previous audio/video interactions.

Returning to FIG. 4, the depicted process can be repeated whenever consumer interaction agent 150 receives/captures an audio/video interaction from the consumer computing device. For example, each time the consumer speaks, the corresponding audio/video content that is sent to consumer interaction agent 150 can be processed to determine the matching audio/video response(s). Notably, not all audio/video content that consumer interaction agent 150 presents to the consumer needs to be selected in this manner. For example, default audio/video clips could be presented to the consumer such as initially (e.g., an audio/video clip with a standard greeting/introduction), while the consumer may be talking (e.g., a video clip in which the recorded/rendered human is listening intently), after an audio/video response is presented, (e.g., a video clip in which the recorded/rendered human is awaiting a response from the consumer), etc. In any case, consumer interaction agent 150 can present audio/video content continuously to maintain the interaction with the consumer without the need or presence of an actual human.

As mentioned above, in some embodiments, the selection of an intent based on the features of an audio/video interaction can also be based on previous interactions with the consumer and/or information known about the consumer. For example, intent extractor 110 could interface with lead database 130 and/or consumer interaction database 140 to obtain additional context for deriving an intent for a particular audio/video interaction and/or for selecting a particular audio/video response based on a derived intent. In this way, the audio/video response that is presented to the consumer can be further customized based on what is known about the consumer and his or her previous interactions.

In some embodiments, consumer interaction agent 150, intent extractor 110, or another component can be configured to transfer a video call (or other audio/video interaction) to an actual human. For example, in some embodiments, when a particular intent is derived from the features of an audio/video interaction, intent extractor 110 may be configured to cause consumer interaction agent 150 to transfer the video call to a sales representative or other agent of business 160 (or otherwise initiate a video call between the consumer and the human). In so doing, consumer interaction agent 150 could provide the text that has been generated from the consumer's audio/video interactions and text of audio/video responses that have been provided to the consumer to thereby provide context to the human. As one example, when intent extractor 110 determines that the intent of an audio/video interaction is to purchase a product or service, the video call could be transferred to a human to close the deal. As another example, when intent extractor 110 determines that an appropriate audio/video response cannot be provided (e.g., when the consumer's question or concern cannot be adequately addressed with any available audio/video clip or rendering), the video call could be transferred to a human to respond appropriately.

As can be seen, embodiments of the present invention enable a consumer interaction agent to appear to the consumer as if it were an actual human, both visually and verbally. Alternatively, the consumer interaction agent can appear as an avatar which may or may not resemble a human. In either case, by presenting audio/video responses that are selected based on the intent of the consumer's audio/video interactions, the consumer can receive prompter service, improved emotional intelligence, more comprehensive expertise, and an overall better experience. Embodiments of the present invention can therefore enhance the consumer experience in a wide variety of interaction scenarios.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similar storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for providing audio/video responses to consumers based on intent derived from features of the consumer's audio/video interactions, the method comprising:
receiving an audio/video interaction from a consumer;
extracting text from the audio/video interaction;
identifying one or more features in the text;
deriving an intent of the audio/video interaction based on the one or more features in the text;
selecting an audio/video response based on the intent; and
presenting the audio/video response to the consumer.

2. The method of claim 1, further comprising:
identifying one or more features in audio/video content of the audio/video interaction;
wherein the intent is derived based also on the one or more features in the audio/video content.

3. The method of claim 1, wherein the audio/video response comprises one of:
an audio/video clip that includes a human speaking; or
a rendering of an avatar speaking.

4. The method of claim 1, wherein identifying the one or more features in the text comprises performing natural language processing to determine one or more tokens that appear in the text.

5. The method of claim 4, wherein identifying the one or more features in the text comprises generating a tokenized version of the text.

6. The method of claim 2, wherein identifying the one or more features in the audio/video content of the audio/video interaction comprises detecting one or more of a tone, body language, or facial expression of the consumer.

7. The method of claim 6, wherein detecting one or more of the tone, body language, or facial expression of the consumer comprises detecting when voice content of the audio/video content represents excitement, reluctance, or uncertainty.

8. The method of claim 6, wherein detecting one or more of the tone, body language, or facial expression of the consumer comprises detecting particular facial expressions or hand gestures.

9. The method of claim 6, wherein the one or more of the tone, body language, or facial expression of the consumer are detected using artificial intelligence.

10. The method of claim 2, further comprising:
associating one or more timestamps with the text;
using the one or more timestamps to link at least one of the one or more features in the text with at least one corresponding feature of the one or more features in the audio/video content.

11. The method of claim 2, wherein selecting the audio/video response based on the intent comprises selecting the audio/video response from among multiple audio/video responses that match the intent that is derived based on the one or more features in the text.

12. The method of claim 11, wherein selecting the audio/video response from among the multiple audio/video responses that match the intent that is derived based on the one or more features in the text comprises selecting the audio/video response based on the intent that is derived based also on the one or more features in the audio/video content.

13. The method of claim 1, wherein the intent is one of busy, busy and anxious, affirmative answer, affirmative answer and sad, affirmative answer and excited, or negative answer.

14. The method of claim 1, wherein presenting the audio/video response to the consumer comprises dynamically generating data for rendering an avatar by which the audio/video response is presented.

15. The method of claim 2, wherein the intent is derived based also on previous interactions with the consumer or information known about the consumer.

16. The method of claim 1, further comprising:
after presenting the audio/video response to the consumer, causing the consumer to be connected with a human.

17. The method of claim 16, further comprising:
providing the text extracted from the audio/video interaction and text of the audio/video response to the human to thereby provide context to the human.

18. One or more computer storage media storing computer executable instructions which when executed implement a method for providing audio/video responses to consumers based on intent derived from features of the consumer's audio/video interactions, the method comprising:
receiving an audio/video interaction from a consumer;
extracting text from the audio/video interaction;
identifying one or more features in the text;
identifying one or more features in audio/video content of the audio/video interaction;
deriving an intent of the audio/video interaction based on the one or more features in the text and the one or more features in the audio/video content;
selecting an audio/video response based on the intent; and
presenting the audio/video response to the consumer.

19. The computer storage media of claim 18, wherein the audio/video response comprises one of:
an audio/video clip that includes a human speaking; or
a rendering of an avatar speaking.

20. A method for providing audio/video responses to consumers based on intent derived from features of the consumer's audio/video interactions, the method comprising:
receiving audio/video interactions from a consumer;
extracting text from the audio/video interactions;
identifying features in the text by using artificial intelligence to detect one or more of a tone, body language, or facial expression of the consumer during the audio/video interactions;
deriving intents of the audio/video interactions based on the features in the text;
selecting audio/video responses based on the intents; and
presenting the audio/video responses to the consumer.
